(19) United States
(12) Patent Application Publication
(10) Pub. No.: US 2008/0215959 A1
(43) Pub. Date: Sep. 4, 2008

(54) METHOD AND SYSTEM FOR GENERATING A MEDIA STREAM IN A MEDIA SPREADSHEET

(76) Inventor: David B. Lection, Raleigh, NC (US)

Correspondence Address: SCENERA RESEARCH, LLC, 111 CORNING RD., SUITE 220, CARY, NC, 27511, US

(21) Appl. No.: 11/680,403

(22) Filed: Feb. 28, 2007

(51) Int. Cl. G06F 17/00; G06F 3/00

(52) U.S. Cl. 715/201; 715/212; 715/220; 715/730

(57) ABSTRACT

Methods and systems are described for generating a media stream in a media spreadsheet. The method includes presenting, via a user interface, an electronic spreadsheet having a plurality of cells. The method also includes receiving an association of a source media stream object with a first cell of the plurality of cells. The method further includes receiving an association of a media stream transformation operation with one of the first cell and a second cell of the plurality of cells, wherein the media stream transformation operation references, respectively, one of the source media stream object and the first cell. The method also includes automatically applying the media stream transformation operation to the source media stream object to generate a resultant media stream object, based on the reference. The method further includes associating the resultant media stream object with at least one of the plurality of cells of the electronic spreadsheet.

### BACKGROUND

In today's spreadsheet applications, spreadsheets are presented as a two-dimensional presentation space. Each addressable location in the spreadsheet is called a cell, and each cell can hold data. The value of a cell can be calculated depending on other cells. As those cells change value, dependent cell values are also recalculated.

Today's spreadsheets are typically limited to text data, for example numbers, and in limited situations image data. In some cases, a spreadsheet will allow a graphic in a cell as a static item of content that aids in the formatting of the spreadsheet. Today's spreadsheets can also render graphs from included data. Today's spreadsheets do not allow for generating a media stream using the spreadsheet.

Accordingly, there exists a need for methods, systems, and computer program products for generating a media stream in a media spreadsheet.

### SUMMARY

Methods and systems are described for generating a media stream in a media spreadsheet. An exemplary method includes presenting, via a user interface, an electronic spreadsheet having a plurality of cells. The method also includes receiving an association of a source media stream object with a first cell of the plurality of cells. The method further includes receiving an association of a media stream transformation operation with one of the first cell and a second cell of the plurality of cells, wherein the media stream transformation operation references, respectively, one of the source media stream object and the first cell. The method also includes automatically applying the media stream transformation operation to the source media stream object to generate a resultant media stream object, based on the reference. The method further includes associating the resultant media stream object with at least one of the plurality of cells of the electronic spreadsheet.

According to another aspect a system for generating a media stream in a media spreadsheet is disclosed. The system includes a user interface component configured for presenting, via a user interface, an electronic spreadsheet having a plurality of cells. The system also includes a cell list manager component configured for receiving an association of a source media stream object with a first cell of the plurality of cells. The cell list manager component is also configured for receiving an association of a media stream transformation operation with one of the first cell and a second cell of the plurality of cells, wherein the media stream transformation operation references, respectively, one of the source media stream object and the first cell. The system still further includes a cell content evaluator component configured for based on the reference, automatically applying the media stream transformation operation to the source media stream object to generate a resultant media stream object. The cell list manager component is also configured for associating the resultant media stream object with at least one of the plurality of cells of the electronic spreadsheet.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for generating a media stream in a media spreadsheet according to an embodiment of the subject matter described herein;

FIG. 2 is a block diagram illustrating a system for generating a media stream in a media spreadsheet according to another embodiment of the subject matter described herein;

FIG. 3 is a block diagram illustrating a detailed view of a media spreadsheet application as shown in FIG. 2 according to an exemplary embodiment of the subject matter described herein; and

FIG. 4 illustrates a user interface for generating a media stream in a media spreadsheet according to another embodiment of the subject matter described herein.

### DETAILED DESCRIPTION

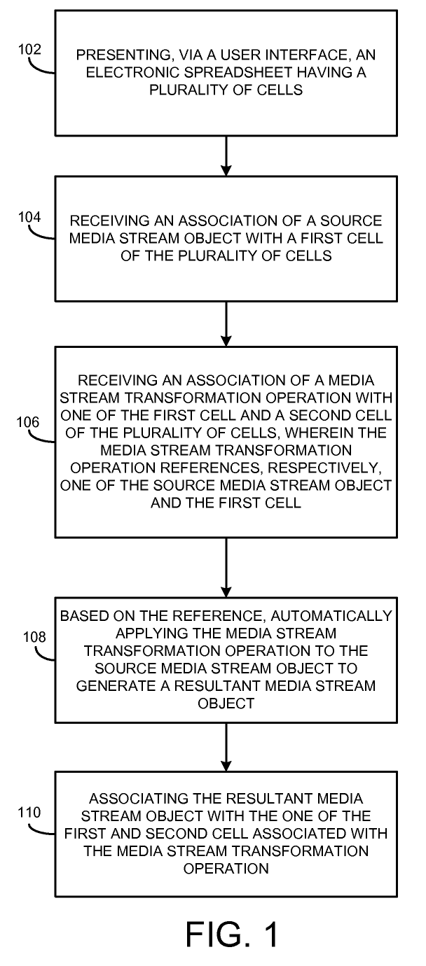

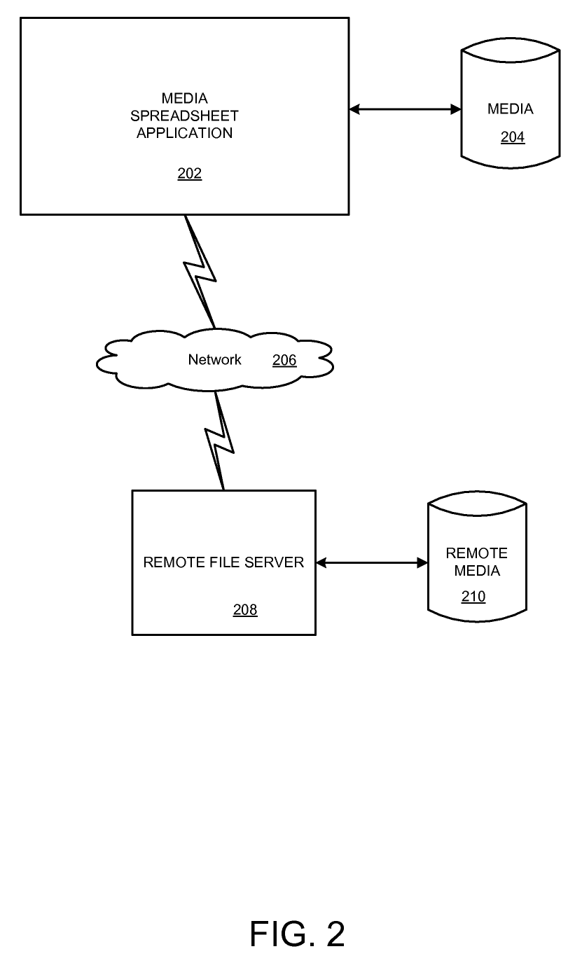

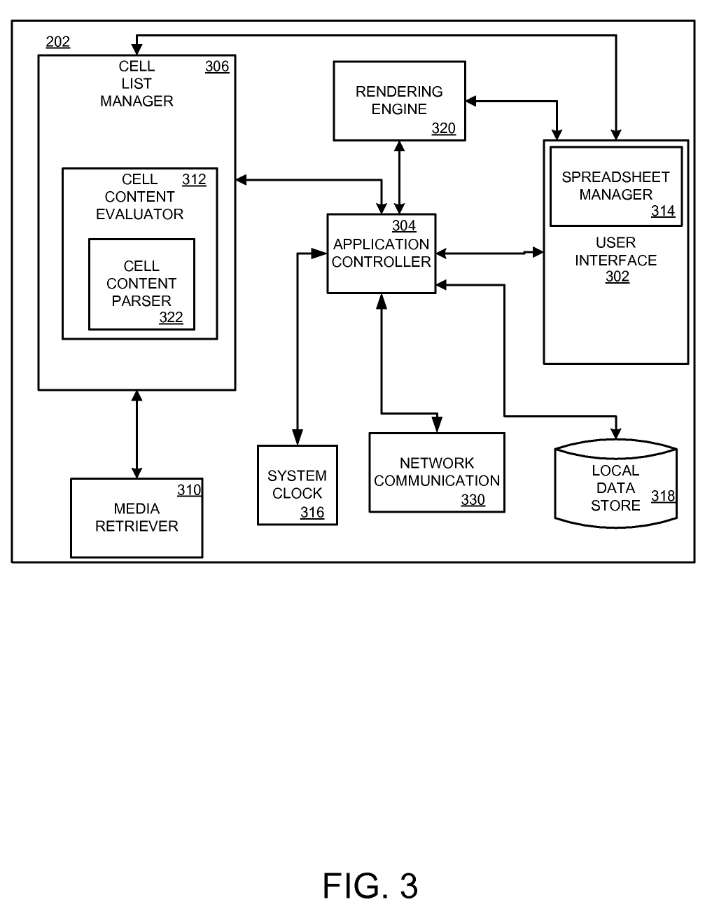

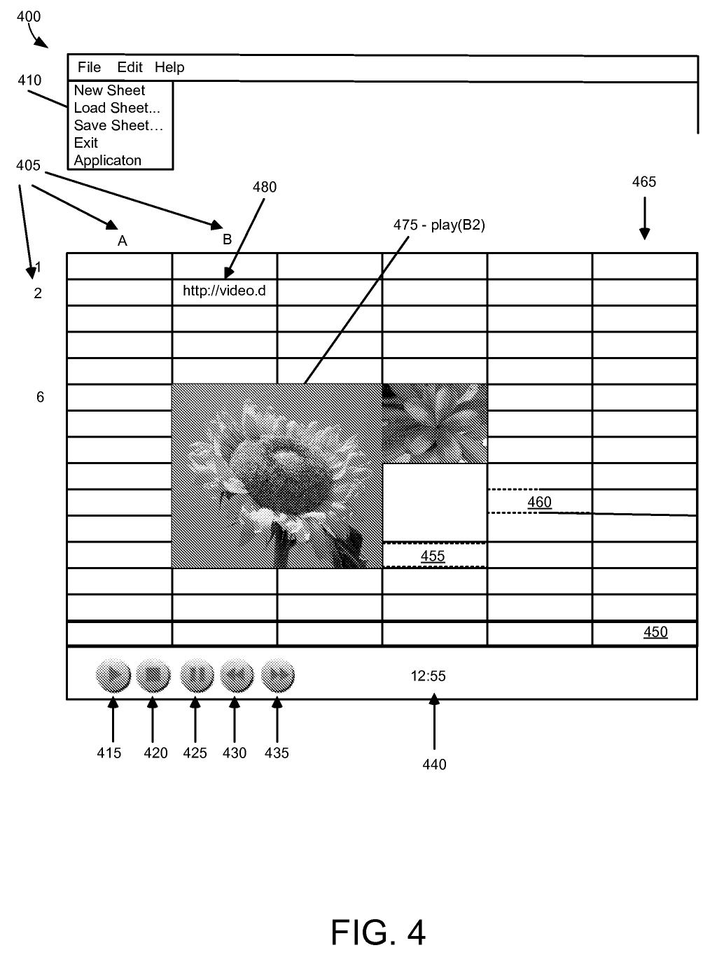

FIG. 1 is a flow diagram illustrating a method for generating a media stream in a media spreadsheet according to an exemplary embodiment of the subject matter described herein. FIG. 2 is a block diagram illustrating a system for generating a media stream in a media spreadsheet according to another exemplary embodiment of the subject matter described herein. FIG. 3 is a block diagram illustrating a system for generating a media stream in a media spreadsheet according to another exemplary embodiment of the subject matter described herein. The method illustrated in FIG. 1 can be carried out by, for example, some or all of the components illustrated in the exemplary system of FIGS. 2 and 3. An exemplary user interface for carrying out the method illustrated in FIG. 1 is shown in FIG. 4.

With reference to FIG. 1, in block 102 an electronic spreadsheet having a plurality of cells is presented via a user interface. Accordingly, a system for generating a media stream in a media spreadsheet includes means for presenting, via a user interface, an electronic spreadsheet having a plurality of cells. For example, as illustrated in FIGS. 2 and 3, a media spreadsheet application 202 includes a user interface component 302. The user interface component 302 is configured for presenting, via a user interface, an electronic spreadsheet having a plurality of cells.

In an embodiment, an application controller component 304 can be used to control the functions of the media spreadsheet application. For exemplary purposes, an embodiment using the application controller component 304 will be described. In an alternate embodiment, an application controller component is not necessary for the media spreadsheet application 202 to function. Each component of the media spreadsheet application 202 can be configured to communicate with the other components of the application 202 without the use of the application controller component 304.

The user interface component 302 presents an electronic spreadsheet having a plurality of cells via the user interface. An exemplary electronic spreadsheet is depicted in FIG. 4. In the illustrated embodiment, the user interface component 302 presents a row and grid spreadsheet GUI 400.

The media spreadsheet can be formatted in a grid pattern with each row and column of the grid having a unique label. In the illustrated embodiment, rows are identified by number, and columns are identified by letter as shown by reference labels 405. At the intersection of each row and column is a cell. An example cell is the cell 480 that includes a reference to a remote mpeg video stream. This cell 480 is at the intersection of the row having the label “2” and the column having the label “B.” As a result, the unique identifier of the cell 480 is the concatenation of the column identifier and the row identifier, or B2.

The user interface component 302 can also present a menu bar 410. The menu bar 410 can include menu commands that allow the user to load a media spreadsheet into the application 202, save a loaded spreadsheet, and to start new spreadsheets. When the user selects a menu command to load, save, or start a new spreadsheet, the application controller component 304 receives a menu command event from the user interface component 302, and routes this command to the spreadsheet manager component 314. The spreadsheet manager component 314 can be configured to, depending on the requested operation, load a new spreadsheet, save the current spreadsheet, or start a new spreadsheet by calling the user interface to clear all the cell contents in the user interface.

The spreadsheet graphical user interface (GUI) 400 depicted in FIG. 4 is representative of a spreadsheet user interface and not intended to be an exhaustive representation of all spreadsheet user interface metaphors, but rather a representative interface that demonstrates the functions unique to the media spreadsheet.

Returning to FIG. 1, in block 104 an association of a source media stream object with a first cell of the plurality of cells is received. Accordingly, a system for generating a media stream in a media spreadsheet includes means for receiving an association of a source media stream object with a first cell of the plurality of cells. For example, as illustrated in FIG. 3, a cell list manager component 306 is configured for receiving an association of a source media stream object with a first cell of the plurality of cells.

An association of a media stream object with a first cell of the plurality of cells can be received via user input. The cell list manager component 306 receives this input and maintains an association of the media stream object with the first cell. For example, user input associated with the spreadsheet cell “B2” 480 can be received. When the user completes entry of the string, the user interface component 302 can send the string to the application controller component 304 using a notification event. The application controller component 304 can send the string value to the cell content parser component 322 for parsing. The cell content parser component 322 can determine that the string is a valid uniform resource locator (URL) reference to a remote media stream, such as “http://video.davidl.com/flowers.mpg.” As illustrated in FIG. 2, the media spreadsheet application 202 can retrieve remote media 210 over a network 206 using a remote file server 208. The URL remains persisted in cell “B2,” and the cell content parser component 322 can call the cell list manager component 306 to insert cell “B2” into the cell evaluation list. The cell list manager component 306 maintains the association of the media stream object with the first cell. Alternatively, the association can be received automatically via a script or other program. Further, the association can be made via a drag and drop of a media stream object into a cell of the media spreadsheet.

Returning to FIG. 1, in block 106 an association of a media stream transformation operation with one of the first cell and a second cell of the plurality of cells is received. The media stream transformation operation references, respectively, one of the source media stream object and the first cell. Accordingly, a system for generating a media stream in a media spreadsheet includes means for receiving an association of a media stream transformation operation with one of the first cell and a second cell of the plurality of cells. For example, as illustrated in FIG. 3, the cell list manager component 306 is configured for receiving an association of a media stream transformation operation with one of the first cell and a second cell of the plurality of cells. The media stream transformation operation references, respectively, one of the source media stream object and the first cell.

The spreadsheet cell “B6” 475 can be associated with user input entered into the cell 475 of the spreadsheet GUI 400. When the user completes entry of input in the form of a string, the user interface component 302 can send the string to the application controller component 304 using a notification event. The application controller component 304 can send the string value to the cell content parser 322 for evaluation. The cell content parser component 322 can be configured to determine whether the string is a media transformation function. The string that represents the function remains persisted in cell “B6” and the cell content parser component 322 calls the cell list manager component 306 to insert cell “B6” into the cell evaluation list.

As described above, cells can include either a stream reference or a media transformation function. Media transformation functions take one or more parameters of input data, and produce an output media stream object. Input data parameters can include simple data items, such as numbers or strings, static data items, such as images, and media stream objects including elementary and compound media stream objects. Any of these input parameters can be a literal value, e.g. “2”, “Joe Smith”, can be referenced from another cell “play(d5)” in the spreadsheet, and/or can be referenced remotely, such as in the function call “Play(“http://video.davidl.com/flowers.mpg”).”

Returning to FIG. 1, in block 108 the media stream transformation operation is automatically applied to the source media stream object to generate a resultant media stream object, based on the reference. Accordingly, a system for generating a media stream in a media spreadsheet includes means for automatically applying the media stream transformation operation to the source media stream object based on the reference to generate a resultant media stream object. For example, as illustrated in FIG. 3, a cell content evaluator component 312 is configured for automatically applying the media stream transformation operation to the source media stream object based on the reference to generate a resultant media stream object.

The cell content evaluator component 312 is configured for evaluating a transformation within a cell in multiple contexts. For example, a first context occurs when a cell's contents are finalized. The user interface component 302 can signal the application controller component 304 when a cell's contents have been modified. The application controller component 304 can call the cell list evaluator component 312 with the address of the changed cell to evaluate the cell's contents. The cell evaluator component 312 can be configured to determine if the evaluation contents of the cell is static and independent of a system clock associated with the media spreadsheet. A second context occurs during the rendering interval for cells whose references to data is dynamic and needs to be re-evaluated on each timer interval of the system clock. These cells are evaluated on the timer interval, and then all cells are rendered.

An example a media transformation function having evaluation contents that are static and independent of a system clock is provided in the following exemplary embodiment of a function configured for creating a slide show from a list of images. Exemplary syntax for the function is:

CreateSimpleSlideShow(B4, B5, B6, B7, 10).

This exemplary function can create a slide show media stream object that is ten seconds long using the contents of cells B4, B5, B6, and B7. Consider in the example that the contents of these cells are:

B4=“C:\images\tulip.jpg”

B5=“C:\images\marigold.jpg”

B6=“C:\images\daffodill.jpg”

B7=“C:\images\RedRose.jpg”

Since the contents of cells B4 through B7 are static—that is, the cell's contents (e.g., the still digital images) do not change over time—the contents of the cell including the above function does not need to be evaluated on each timer interval of the system clock associated with the media spreadsheet application. The spreadsheet application can take advantage of this condition by pre-evaluating the function and storing the final media stream object in temporary storage. This process optimizes the rendering process, as this cell's contents can be rendered from the stream already assembled.

When any cell included in the spreadsheet is rendered, the contents of the cell are evaluated from the “inside out.” Transformation functions can be included as parameters within the outermost function included in a cell, and the outermost function's evaluation determines the final value of the cell. An example of this technique building upon the exemplary slideshow function described above follows:

### CreateSimpleSlideShow(RandomCell(B4, B7),

RandomCell(B6, B7),
RandomCell(B4, B5),
RandomCell(B5, B7), 10)

The inner functions, “RandomCell,” select a cell from their input list of cells as a random cell. These inner functions return a selected cell reference to the outermost function, “CreateSimpleSlideShow.” The final value of the outermost function in this example is a slide show, including four images at random, for a total presentation length of ten seconds. The cell content evaluator component 306 can be configured to evaluate each cell in the cell list. The result of a cell's evaluation can result in a numeric value, string, static item such a list, a cell reference, or a direct reference to media stream.

In another aspect, the source media stream object can be a compound media stream object including a plurality of media stream objects. For example, the media stream object can include both a video stream and an audio stream. In this case, applying a media stream transformation operation can include extracting one of a plurality of media stream objects from the compound media stream object and generating a resultant media stream object including the extracted media stream object. For example, the cell content evaluator component 312 can be configured for extracting one of a plurality of media streams from the compound media stream object generating a resultant media stream object including the extracted media stream. The cell content evaluator component 312 can extract the video stream from the compound media stream object described above.

In another aspect, applying the media stream transformation operation can include applying a time shift transformation to the source media stream object wherein the resultant media stream object includes content in the source media stream object shifted in time according to a definable time interval in relation to a common time base. For example, the cell content evaluator component 312 can be configured for applying a time shift transformation to the source media stream object wherein the resultant media stream object includes content in the source media stream object shifted in time according to a definable timer interval in relations to the system clock associated with the media spreadsheet application. A ten second offset can be included in a source media stream object to shift the time of play of the media stream object by ten seconds, similar to the slide show example described above.

In another aspect, applying the media stream transformation operation includes combining the source media object with a second media stream object. The generated resultant media stream object can include content in the source media stream object interleaved with content in the second media stream object. For example, the cell content evaluator component 312 can be configured for applying the media stream transformation operation by combining the source media object with a second media stream object. The generated resultant media stream object can include content in the source media stream object interleaved with content in the second media stream object. For example, the source media stream object can include video stream content and the second media stream object can also include video stream content. Interleaving the content of the two media stream objects can result in a media stream object that includes content from each of the media stream objects interspersed throughout the resultant media stream object.

In another aspect, applying the media stream transformation operation includes combining the source media object with a second media stream object. The generated resultant media stream object can include content in the source media stream object overlaid with content in the second media stream object. For example, the cell content evaluator component 312 can be configured for combining the source media object with a second media stream object, allowing the generated resultant media stream object to include content in the source media stream object overlaid with content in the second media stream object.

Consider, for example, that a source media stream object includes video stream content and that the second media stream object includes audio content. The resultant media stream object can include the video content from the source media stream object overlaid with the audio content from the second media stream object. Thus, the audio content can serve as a soundtrack for the video content. A user could generate a sports highlight clip with this function including video highlights of a sporting event overlaid with a song. In another example the source media stream object can include video stream content and the second media stream object can also include video stream content. In this example, the overlay function can be used to create a “picture-in-picture” type presentation of the two video streams in a single media stream object.

In another aspect, applying the media stream transformation operation can include combining content in the source media stream object with content in a second media stream object. The generated resultant media stream object can include the content in the source media stream object and the content in the second media stream object combined sequentially. For example, the cell content evaluator component 312 can be configured for combining content in the source media stream object with content in a second media stream object, allowing the generated resultant media stream object to include the content in the source media stream object and the content in the second media stream object combined sequentially. This function can operate on video streams as described in conjunction with the slideshow example above. In an arrangement where the media stream objects being combined each include video streams, the two video streams are combined into a single media stream object that presents the video streams sequentially (i.e., one following the other in relation to the system clock associated with the media spreadsheet application).

In another aspect, applying the media stream transformation operation includes adding a transition to the generated media stream object. The transition is configured for sequentially combining the source and second media stream objects. For example, the cell content evaluator component 312 can be configured for applying the media stream transformation operation by adding a transition to a media sequence including the source media stream object, the second media stream object, and a transition separating the source and second media stream objects. It can be difficult to distinguish the end of a first video stream from the beginning of a second video stream. Adding a transition separating the two video streams allows a single media object to play both streams sequentially with the transition providing an indication of the two separate streams.

Returning to FIG. 1, in block 110 the resultant media stream object is associated with at least one of the plurality of cells of the electronic spreadsheet. Accordingly, a system for generating a media stream in a media spreadsheet includes means for associating the resultant media stream object with at least one of the plurality of cells of the electronic spreadsheet. For example, as illustrated in FIG. 3, a cell list manager component 306 is configured for associating the resultant media stream object with at least one of the plurality of cells of the electronic spreadsheet.

After the media stream transformation operation is applied, a resultant media stream object is generated. The cell list manager component 306 associates the resultant media stream object with one of the plurality of cells of the electronic spreadsheet. Once associated with the cell, the resultant media stream object can be used in future transformations or other operations.

For example, the resultant media stream object can be published to a remote media storage component. As illustrated in FIG. 2, the media spreadsheet application 202 can retrieve remote media 210 over a network 206 using a remote file server 208. The media spreadsheet application 202 can include a network communication component 330 configured for publishing the resultant media stream object to a remote media storage component.

In another example, the resultant media stream object can be presented via the electronic spreadsheet. For example, a rendering engine component 320 can be included in the media spreadsheet application 202. The rendering engine component 320 can be configured for presenting the resultant media stream object via the electronic spreadsheet. Presenting the media object can begin automatically or require input to begin. In an aspect, the resultant media stream object is presented in the electronic spreadsheet in response to an activation of a present function included in the electronic spreadsheet. For example, the rendering engine component 320 can be configured for presenting the resultant media stream object in the electronic spreadsheet in response to receiving a selection of a play button in the electronic spreadsheet.

When a spreadsheet has been loaded into the application 202, cells that include the present function referencing a video stream media object can cause the rendering engine component 320 to render the streams in a visual manner. For example, in FIG. 4, cell 475 presents an mpeg video stream that includes images of sunflowers is shown as rendered by rendering engine component 320.

The streams of a media spreadsheet can be synchronized. The time used for synchronizing can be generated by a system clock component 316. The system clock component 316 can be configured to track time while the spreadsheet is played or presented. In another aspect, the resultant media stream object can be presented in the electronic spreadsheet synchronously with at least one of the source media stream object and another media stream object associated with a third cell included in the electronic spreadsheet. For example, the system clock component 316 can be configured for returning a time. The rendering engine component can be configured for playing or presenting the resultant media stream object in the electronic spreadsheet synchronously with at least one of the source media stream object and another media stream object associated with the third cell according to the time returned by the system clock component 316. Thus, the two media streams will begin playing (or being presented) at the same time, and a common time base may be used to reference each of the streams.

When the play button 415 in the electronic spreadsheet is activated, the user interface component 302 can send an event to the application controller component 304. The application controller component 304 can invoke the system clock component 316 to receive timing events. These events can be forwarded to the cell list manager component 306. The cell list manager component 306, upon completing evaluation of cell contents for a particular timing interval, can call the rendering engine component 318 to render the contents of each cell including a present function.

The stop button 420, when activated, stops the playing (or presentation) of the spreadsheet. The activating of the stop button 420 not only stops the rendering of the spreadsheet, but also can reset the system clock to zero. The streams can be fast-forwarded or rewound by activating the rewind 430 and fast forward 435 buttons, respectively. The streams can also be temporarily paused by the activating of the pause button 425. A cell may also include a when function for invoking functions associated with the stream. For example, the stop function or the pause function the playing or presentation of a stream in response to the occurrence of a parameter. For example, the when function may stop or pause the presentation of a stream upon the passing of a specified timer interval. In another example, the when function may stop or pause the presentation of a stream upon the identification of a specified metadata element in the stream.

While a spreadsheet is playing (or being presented), at each timer interval, the system clock can notify the application controller component 304 to perform spreadsheet evaluation and rendering. The application controller component 304 can call the cell list manager component 306 to evaluate the list of cells. If needed, the cell list manager component can call a media retriever component 310 to retrieve stream contents of a cell represented by one of a media transformation function and a stream reference included in a cell. As the content streams are resolved for each cell, cells that include the present function can be rendered within the spreadsheet application by the rendering engine component 318.

While the spreadsheet can render remote, real-time media streams, the ability to fast-forward and rewind these streams can be limited based on the availability of the entire stream's contents. Multi-cast video and audio streams are typically temporal in nature and cannot be fast-forwarded. The spreadsheet application can be configured to stage (or queue) these streams to a local temporary storage component 318, thereby allowing the ability to rewind and playback these temporal streams. When the contents of a cell being rendered are not available because of the spreadsheet timing or a reference error in the cell formula, a visual indication of such can be provided in the affected cell.

It should be understood that the various components illustrated in the various block diagrams represent logical components that are configured to perform the functionality described herein and can be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n), a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

1. A method for generating a media stream in a media spreadsheet, the method comprising:
presenting, via a user interface, an electronic spreadsheet having a plurality of cells;
receiving an association of a source compound media stream object with a first cell of the plurality of cells, wherein the source compound media stream object includes a plurality of media streams;
receiving an association of a media stream transformation operation with one of the first cell and a second cell of the plurality of cells, wherein the media stream transformation operation references, respectively, one of the source compound media stream object and the first cell and the media stream transformation operation includes extracting one of the plurality of media streams from the compound media stream object;
based on the reference, automatically applying the media stream transformation operation to the source compound media stream object to generate a resultant media stream object including the extracted media stream; and
associating the resultant media stream object with at least one of the plurality of cells of the electronic spreadsheet.

2. (canceled)

3. (canceled)

4. The method of claim 1 wherein applying the media stream transformation operation includes applying a time shift transformation to the source media stream object wherein the resultant media stream object includes content in the source media stream object shifted in time according to a definable time interval in regard to a common time base.

5. The method of claim 1 wherein applying the media stream transformation operation includes combining the source media object with a second media stream object, wherein the generated resultant media stream object includes content in the source media stream object interleaved with content in the second media stream object.

6. The method of claim 1 wherein applying the media stream transformation operation includes combining the source media object with a second media stream object wherein the generated resultant media stream object includes content in the source media stream object overlaid with content in the second media stream object.

7. The method of claim 1 wherein applying the media stream transformation operation includes combining content in the source media stream object with content in a second media stream object wherein the generated resultant media stream object includes the content in the source media stream object and the content in the second media stream object combined sequentially.

8. The method of claim 7 wherein applying the media stream transformation operation includes adding a transition to the generated media stream object, the transition for sequentially combining the source and second media stream objects.

9. The method of claim 1 including publishing the resultant media stream object to a remote media storage component.

10. The method of claim 1 including presenting the resultant media stream object via the electronic spreadsheet.

11. The method of claim 10 wherein the resultant media stream object is presented in the electronic spreadsheet in response to an activation of a present function included in the electronic spreadsheet.

12. The method of claim 10 wherein the resultant media stream object is presented in the electronic spreadsheet synchronously with at least one of the source media stream object and another media stream object associated with a third cell included in the electronic spreadsheet.

13. A system for generating a media stream in a media spreadsheet, the system comprising:
means for presenting, via a user interface, an electronic spreadsheet having a plurality of cells;
means for receiving an association of a source compound media stream object with a first cell of the plurality of cells, wherein the source compound media stream object includes a plurality of media streams;
means for receiving an association of a media stream transformation operation with one of the first cell and a second cell of the plurality of cells, wherein the media stream transformation operation references, respectively, one of the source compound media stream object and the first cell and the media stream transformation operation includes extracting one of the plurality of media streams from the compound media stream object;
means automatically applying the media stream transformation operation to the source compound media stream object to generate a resultant media stream object including the extracted media stream; and
means for associating the resultant media stream object with at least one of the plurality of cells of the electronic spreadsheet.

14. A system for generating a media stream in a media spreadsheet, the system comprising:
a user interface component configured for presenting, via a user interface, an electronic spreadsheet having a plurality of cells;
a cell list manager component configured for receiving an association of a source compound media stream object with a first cell of the plurality of cells wherein the source compound media stream object includes a plurality of media streams, the cell list manager component further configured for receiving an association of a media stream transformation operation with one of the first cell and a second cell of the plurality of cells, wherein the media stream transformation operation references, respectively, one of the source compound media stream object and the first cell and the media stream transformation operation includes extracting one of a plurality of media streams from the compound media stream object; and
a cell content evaluator component configured for based on the reference, automatically applying the media stream transformation operation to the source compound media stream object to generate a resultant media stream object including the extracted media stream wherein the cell list manager component is configured for associating the resultant media stream object with at least one of the plurality of cells of the electronic spreadsheet.

15. (canceled)

16. (canceled)

17. The system of claim 14 wherein the cell content evaluator component is configured for applying a time shift transformation to the source media stream object wherein the resultant media stream object includes content in the source media stream object shifted in time according to a definable time interval in regard to a common time base.

18. The system of claim 14 wherein the cell content evaluator component is configured for applying the media stream transformation operation includes combining the source media object with a second media stream object wherein the generated resultant media stream object includes content in the source media stream object interleaved with content in the second media stream object.

19. The system of claim 18 wherein the cell content evaluator component is configured for combining the source media object with a second media stream object wherein the generated resultant media stream object includes content in the source media stream object overlaid with content in the second media stream object.

20. The system of claim 18 wherein the cell content evaluator component is configured for combining content in the source media stream object with content in a second media stream object wherein the generated resultant media stream object includes the content in the source media stream object and the content in the second media stream object combined sequentially.

21. The system of claim 20 wherein the cell content evaluator component is configured for applying the media stream transformation operation includes adding a transition to the media sequence wherein the media sequence includes the source media stream object, the second media stream object, and a transition separating the media stream objects.

22. The system of claim 14 including a network communication component configured for publishing the resultant media stream object to a remote media storage component.

23. The system of claim 14 including a rendering engine component configured for playing the resultant media stream object via the electronic spreadsheet.

24. The system of claim 23 wherein the rendering engine component is configured for playing the resultant media stream object in the electronic spreadsheet in response to receiving a selection of a play button in the electronic spreadsheet.

25. The system of claim 23 including a system clock component configured for returning a time, wherein the rendering engine component is configured for playing the resultant media stream object in the electronic spreadsheet synchronously with at least one of the source media stream object and another media stream object associated with a third cell included in the electronic spreadsheet according to the time returned by the system clock component.

26. A computer readable medium including a computer program, executable by a machine, for generating a media stream in a media spreadsheet, the computer program comprising executable instructions for:
presenting, via a user interface, an electronic spreadsheet having a plurality of cells;
receiving an association of a source compound media stream object with a first cell of the plurality of cells, wherein the source compound media stream object includes a plurality of media streams;
receiving an association of a media stream transformation operation with one of the first cell and a second cell of the plurality of cells, wherein the media stream transformation operation references, respectively, one of the source compound media stream object and the first cell and the media stream transformation operation includes extracting one of the plurality of media streams from the compound media stream object;
based on the reference, automatically applying the media stream transformation operation to the source compound media stream object to generate a resultant media stream object including the extracted media stream; and
associating the resultant media stream object with at least one of the plurality of cells of the electronic spreadsheet.
